(19) United States
(12) Patent Application Publication
(10) Pub. No.: US 2010/0198411 A1
(43) Pub. Date: Aug. 5, 2010

(54) VENTILATION SYSTEM

(76) Inventor: Jason Wolfson, Marshfield, MA (US)

Correspondence Address: FISH & RICHARDSON PC, P.O. BOX 1022, MINNEAPOLIS, MN, 55440-1022, US

(21) Appl. No.: 12/617,192

(22) Filed: Nov. 12, 2009

Related U.S. Application Data
(60) Provisional application No. 61/148,641, filed on Jan. 30, 2009.

(51) Int. Cl. G05B 15/00

(52) U.S. Cl. 700/275

(57) ABSTRACT

A method for controlling a fan and a light. A ventilation time period length is established. During a predetermined period of time: (i) the light is operated in response to a user placing a controller in a first state; (ii) the fan is operated during a first period of time corresponding to the time when the light is in operation, in response to the controller being placed in the first state; (iii) operation of the light is discontinued in response to the controller entering a second state; (iv) operation of the fan is discontinued in response to the controller entering the second state; and (v) the fan is automatically operated for a second period of time in addition to said first period of time, when the light is not in operation, such that the fan is operational for a total period of time having at least the ventilation time period length.

### BACKGROUND

This description relates to a ventilation system.

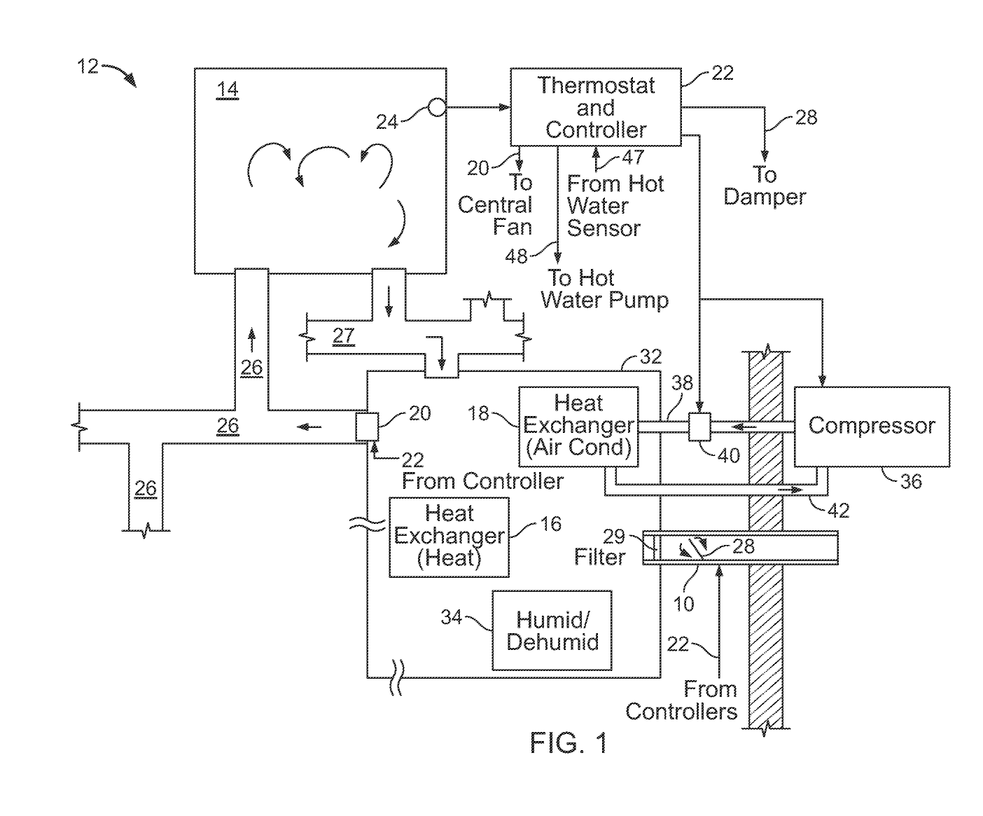

During the 1990s, the United States Department of Energy sponsored research on how to save energy in heating and cooling houses and other buildings. As shown in FIG. 1, one recommendation that has begun to be widely adopted is to super-insulate buildings, seal them tightly against air infiltration, and use a vent 10 from the outside world 12 to let in fresh air. The fresh air is needed to clear odors and humidity from the tightly sealed spaces 14 that are occupied within the buildings. The energy savings produced by such a system are so large that it is expected that, in the future, most new buildings will be super-insulated and tightly sealed.

As is typical of forced air heating or cooling systems, the heater or cooler 16, 18 (and a central fan 20) is turned on and off in response to a thermostat and controller 22 based on a comparison of a set point temperature and a current air temperature measured at a temperature sensor 24. The central fan 20 forces air from the heater or cooler through ducts 26 into the occupied spaces 14. Stale air is withdrawn from the spaces through return ducts 27 and returned to the intake side of the air handler. While the heater or cooler is running, the stale returned air is supplemented with fresh air that is drawn into the building through the vent 10. A damper 28 inside vent 10 is set in a fixed position to permit no more than a suitable amount of fresh air to be drawn in while the heater or cooler is running.

Even during intervals when the heater or cooler is not running, fresh air continues to be needed, and for this purpose, the central fan may be run from time to time during those intervals.

Ventilation systems are generally sized so that they run almost full-time during the coldest or warmest months. When a system that draws in fresh air from the outside world runs all the time, more air is drawn in than is needed for air exchange purposes, and energy is wasted in heating or cooling it. By motorizing the damper 28, it is possible to open and close the damper in cycles to reduce the amount of fresh air drawn into the building. In some systems, a user can specify the proportion of time that the damper is opened to permit fresh air to be drawn in. A replaceable filter 29 is included in the vent to filter the incoming air.

The cooler and/or heater are part of what is often called an air handler 32, which may also include a humidifier and/or a dehumidifier 34, and a variety of other equipment. A variety of configurations are used for air handlers, the equipment that is in them, and the equipment to which they are connected.

The air in the air handler can be heated and/or cooled in a variety of ways. A typical cooler includes the heat exchanger 18, a compressor 36 located outside the building, a delivery conduit 38 with a pump 40 to force coolant from the compressor to the exchanger and a return conduit 42 to carry used coolant back to the compressor. The pump is controlled by the controller 22.

### SUMMARY

In general, in one aspect, there is disclosed a method for controlling a fan and a light, comprising establishing a ventilation time period length; and during a predetermined period of time: (i) operating said light in response to a user placing a controller in a first state; (ii) operating the fan during a first period of time corresponding to the time when the light is in operation, in response to the controller being placed in the first state; (iii) discontinuing operation of the light in response to the controller entering a second state; (iv) discontinuing operation of the fan in response to the controller entering the second state; and (v) automatically operating the fan for a second period of time in addition to said first period of time, when the light is not in operation, such that the fan is operational for a total period of time having at least the ventilation time period length.

Some implementations may include one or more of the following features. Establishing a delay time period length; and during the predetermined period of time, in response to the controller entering the second state, operating the fan for a third period of time after the first period of time, the third period of time having at least the delay time period length. Automatically operating the fan for the second period of time in addition to the first period of time and the third period of time, when the light is not in operation, such that the fan is in operation during the predetermined period of time for a total period of time having at least the ventilation time period length. After the controller has entered the second state, in response to a user action in connection with the controller, discontinuing operation of the fan. The user action comprises, after the controller is in the second state, causing the controller to be sequentially placed in the first state and the second state within a predefined interval of time. In response to the controller entering the second state, operating the fan for a third period of time after the first period of time if the first period of time has at least a certain length. If a total time comprising the first period of time and the third period of time has a length that exceeds the ventilation time period length by an excess time amount, subtracting the excess time amount from a next ventilation time period length corresponding to a next predetermined period of time. The ventilation time period length is specified by a user. The delay time period length is specified by a user. The fan comprises a bathroom exhaust fan.

In general, in one aspect, there is disclosed a medium bearing instructions for controlling a fan and a light, the instructions causing a machine to: establish a ventilation time period length; and during a predetermined period of time: (i) operate said light in response to a user placing a controller in a first state; (ii) operate the fan during a first period of time corresponding to the time when the light is in operation, in response to the controller being placed in the first state; (iii) discontinue operation of the light in response to the controller entering a second state; (iv) discontinue operation of the fan in response to the controller entering the second state; and (v) automatically operate the fan for a second period of time in addition to said first period of time, when the light is not in operation, such that the fan is operational for a total period of time having at least the ventilation time period length.

Some implementations may include one or more of the following features. Instructions to cause a machine to: establish a delay time period length; and during the predetermined period of time, in response to the controller entering the second state, operate the fan for a third period of time after the first period of time, the third period of time having at least the delay time period length. Instructions to cause a machine to: automatically operate the fan for the second period of time in addition to the first period of time and the third period of time, when the light is not in operation, such that the fan is in operation during the predetermined period of time for a total period of time having at least the ventilation time period length. Instructions to cause a machine to: after the controller has entered the second state, in response to a user action in connection with the controller, discontinue operation of the fan. The user action comprises after the controller is in the second state causing the controller to be sequentially placed in the first state and the second state within a predetermined time interval. Instructions to cause a machine to: in response to the controller entering the second state, operate the fan for a third period of time after the first period of time if the first period of time has at least a certain length. Instructions to cause a machine to: if a total time comprising the first period of time and the third period of time has a length that exceeds the ventilation time period length by an excess time amount, subtract the excess time amount from a next ventilation time period length corresponding to a next predetermined period of time.

In general, in one aspect, there is disclosed a controller for controlling a fan and a light comprising a switch; a processor in communication with the switch a first control in communication with the processor to establish a ventilation time period length; and wherein said processor and switch control the light and the fan by, during a predetermined period of time: (i) operating the light in response to a user placing the switch in a first state; (ii) operating the fan during a first period of time corresponding to the time when the light is in operation, in response to the switch being placed in the first state; (iii) discontinuing operation of the light in response to the switch entering a second state; (iv) discontinuing operation of the fan in response to the switch entering the second state; and (v) automatically operating the fan for a second period of time in addition to said first period of time, when the light is not in operation, such that the fan is operational for a total period of time having at least the ventilation time period length.

Some implementations may include one or more of the following features. A second control in communication with the processor, to establish a delay time period length; the processor configured to, during the predetermined period of time, in response to the controller entering the second state, operate the fan for a third period of time after the first period of time, the third period of time having at least the delay time period length. The processor is configured to automatically operate the fan for the second period of time in addition to the first period of time and the third period of time, when the light is not in operation, such that the fan is in operation during the predetermined period of time for a total period of time having at least the ventilation time period length. The processor is configured to, after the switch has entered the second state, in response to a user action in connection with the switch, discontinue operation of the fan. The user action comprises after the switch is in the second state causing the switch to be sequentially placed in the first state and the second state within a predefined interval of time. The processor is configured to, in response to the switch entering the second state, operate the fan for a third period of time after the first period of time if the first period of time has at least a certain length. The processor is configured to, if a total time comprising the first period of time and the third period of time has a length that exceeds the ventilation time period length by an excess time amount, subtract the excess time amount from a next ventilation time period length corresponding to a next predetermined period of time.

Other advantages and features will become apparent from the following description and from the claims.

### DESCRIPTION

FIG. 1 is a schematic diagram of a ventilation system.

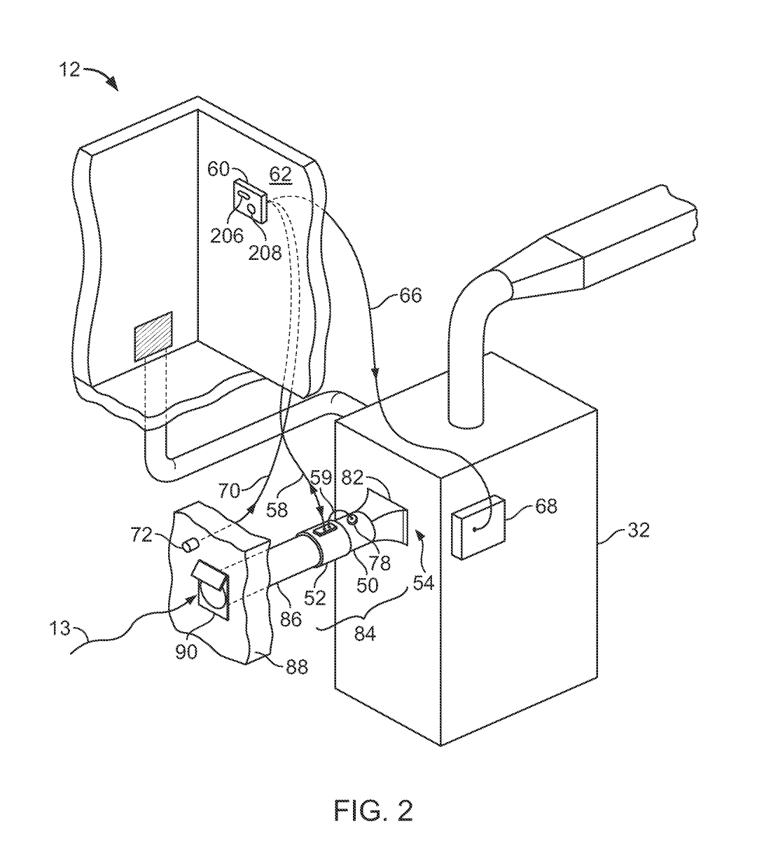

FIG. 2 is a three-dimensional view of portions of a ventilation system.

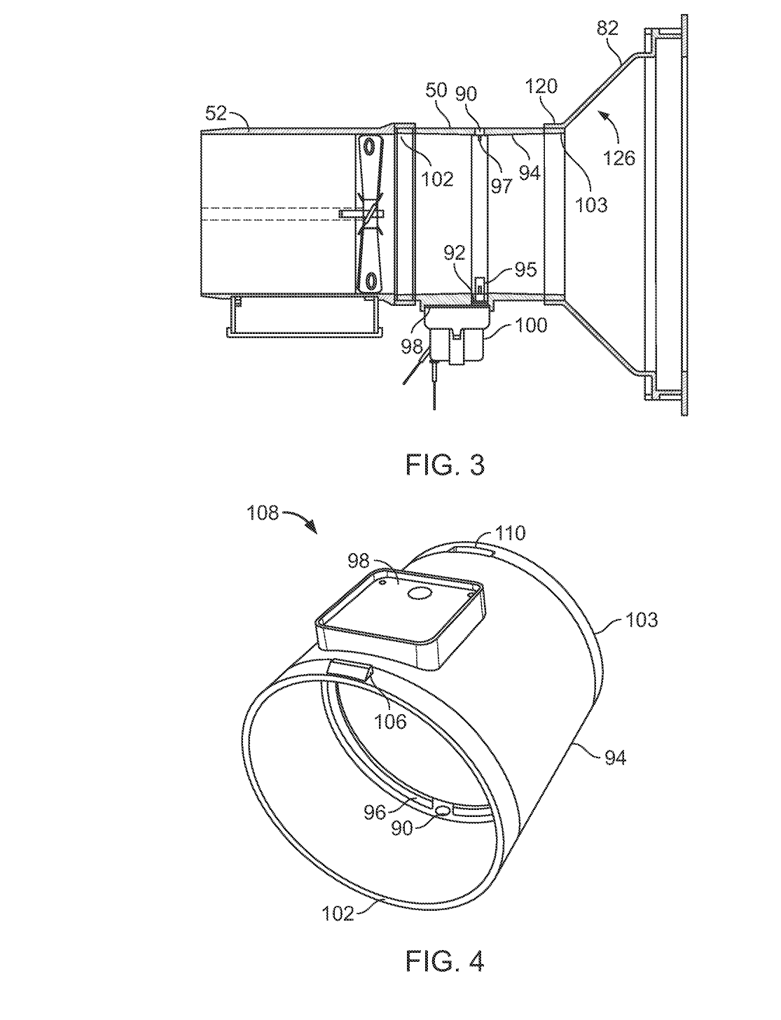

FIGS. 3 and 9 are a sectional side view and a top view of an assembly.

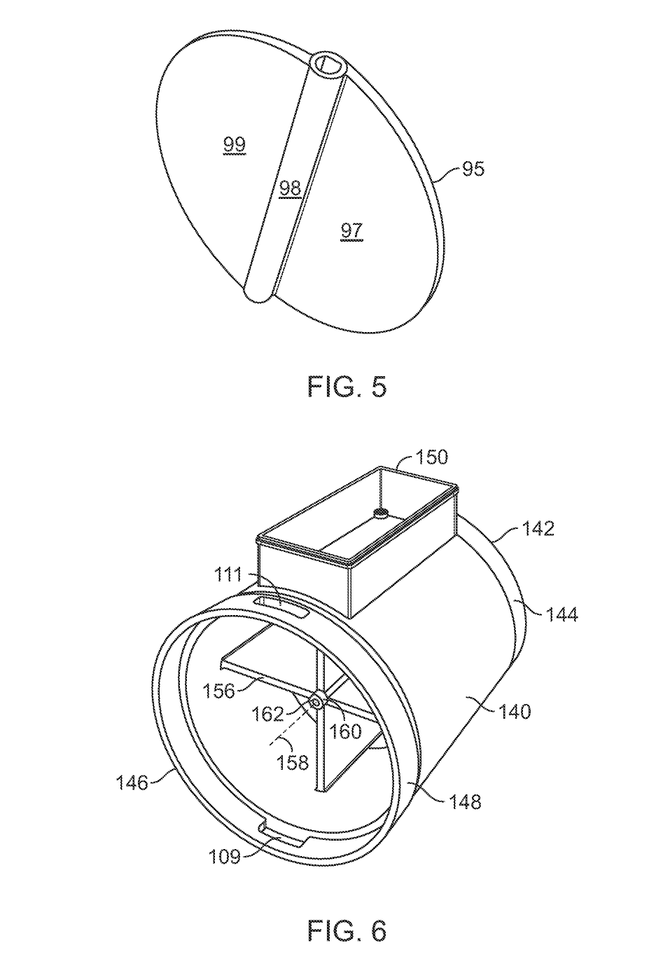

FIGS. 4 and 5 are perspective views of parts of a damper.

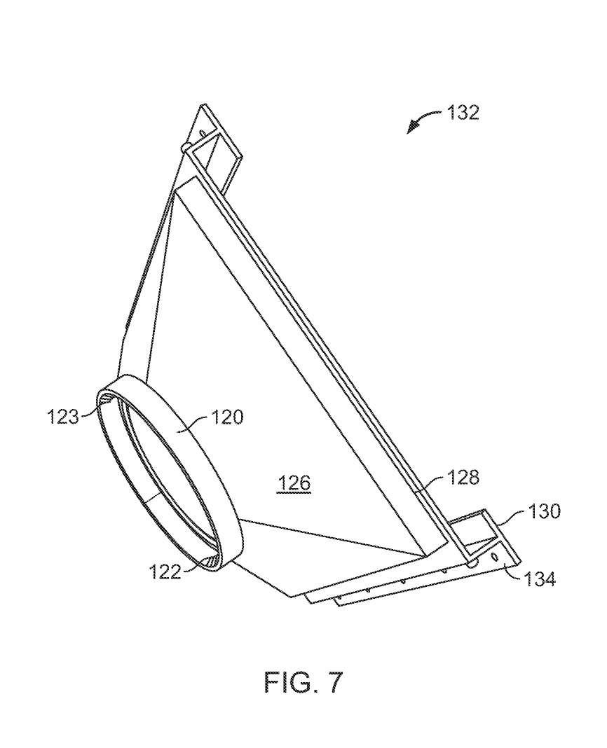

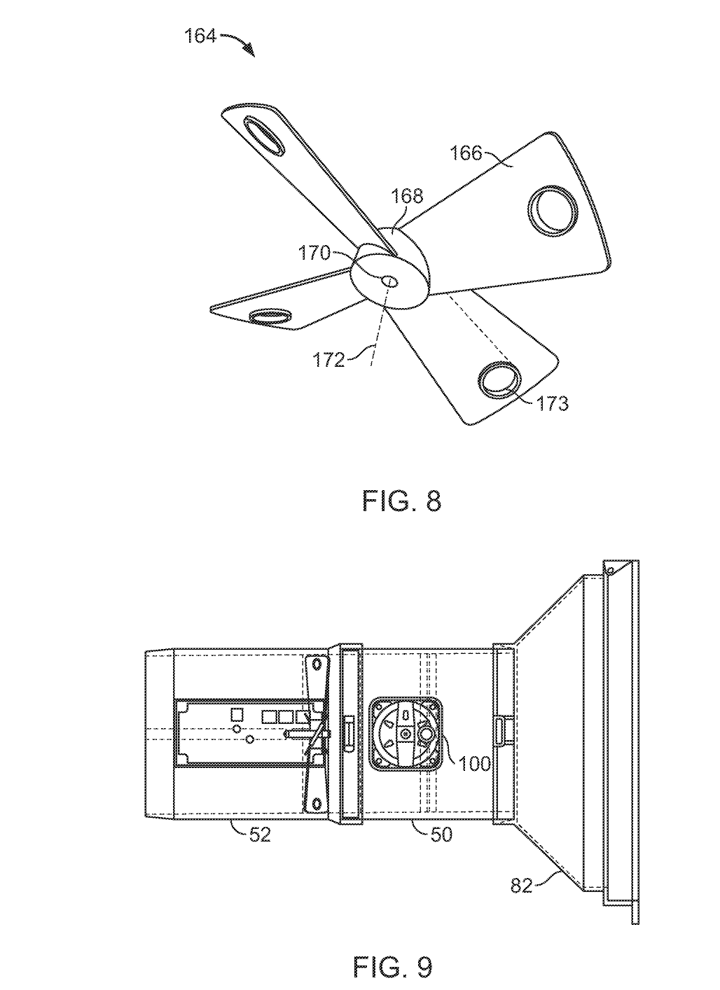

FIGS. 6 and 8 are perspective views of parts of an airflow sensor.

FIG. 7 is a perspective view of a flange/filter housing.

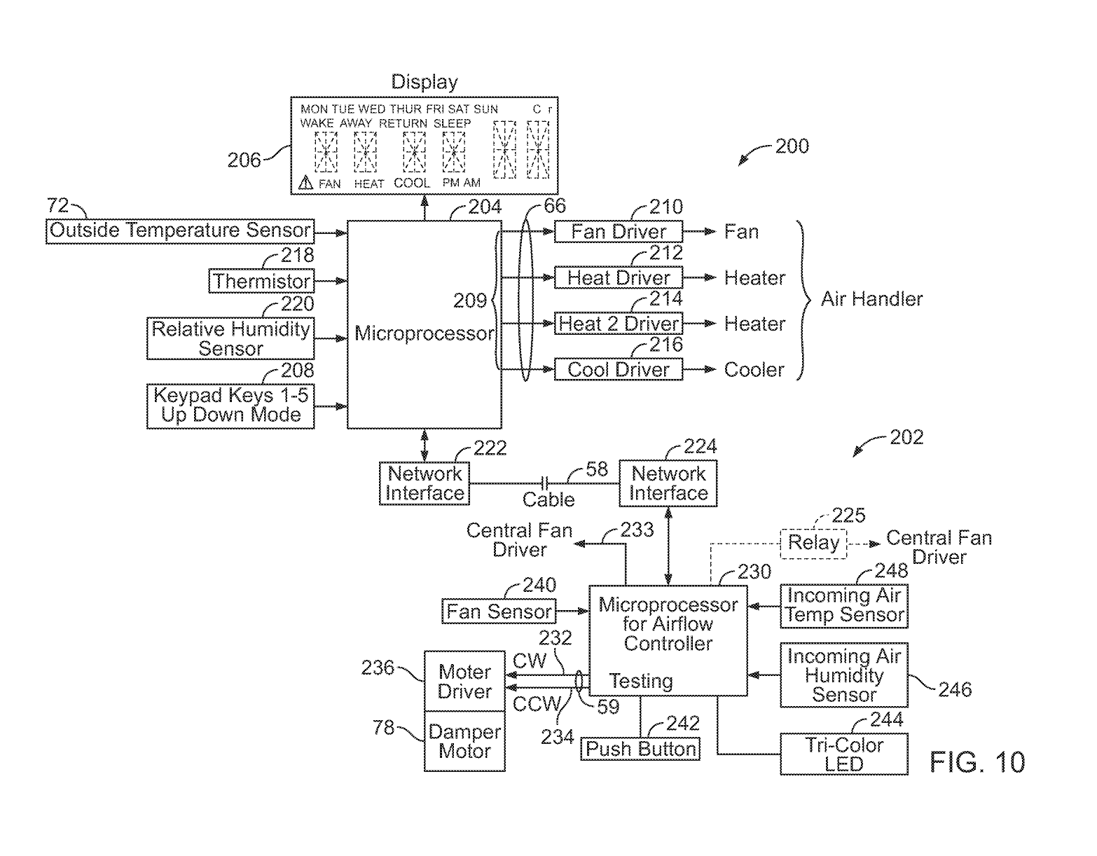

FIG. 10 is a schematic diagram of a control system.

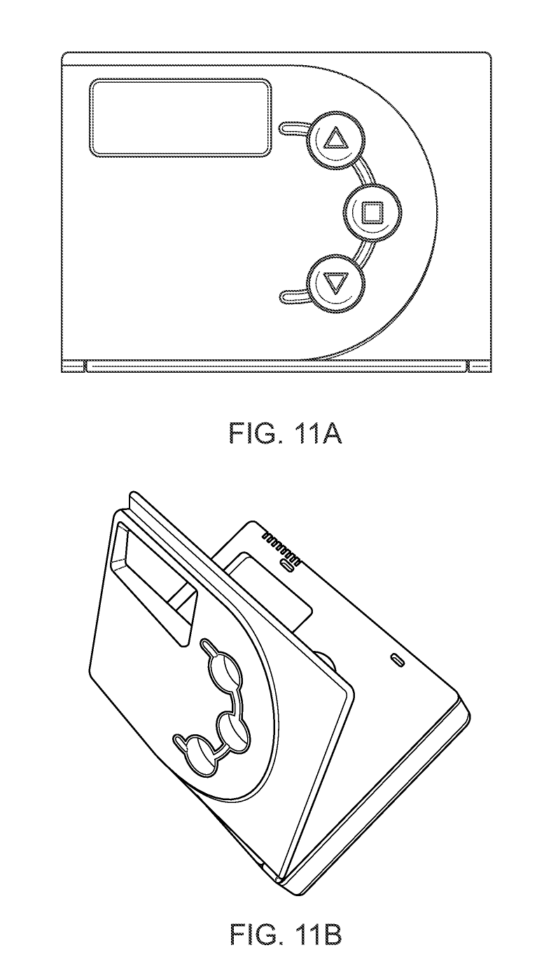

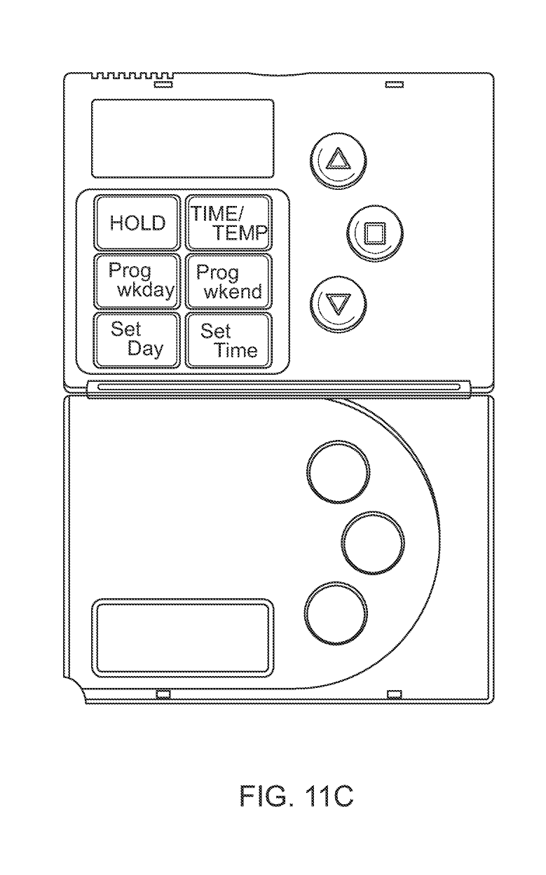

FIGS. 11A, 11B, and 11C are views of a controller.

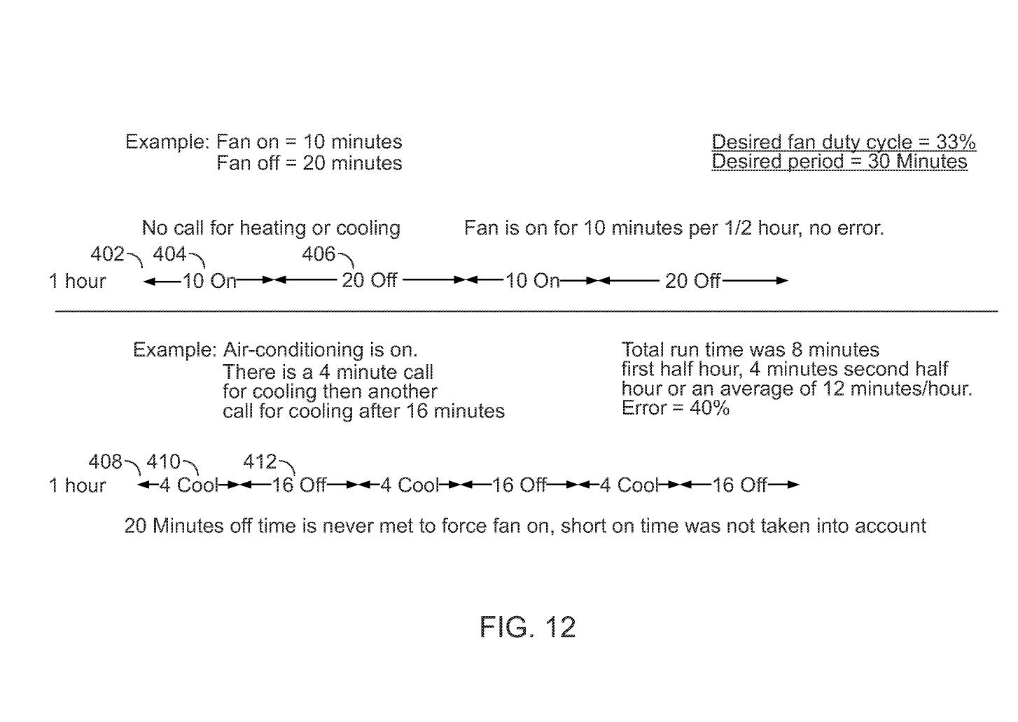

FIGS. 12 through 15 are time lines.

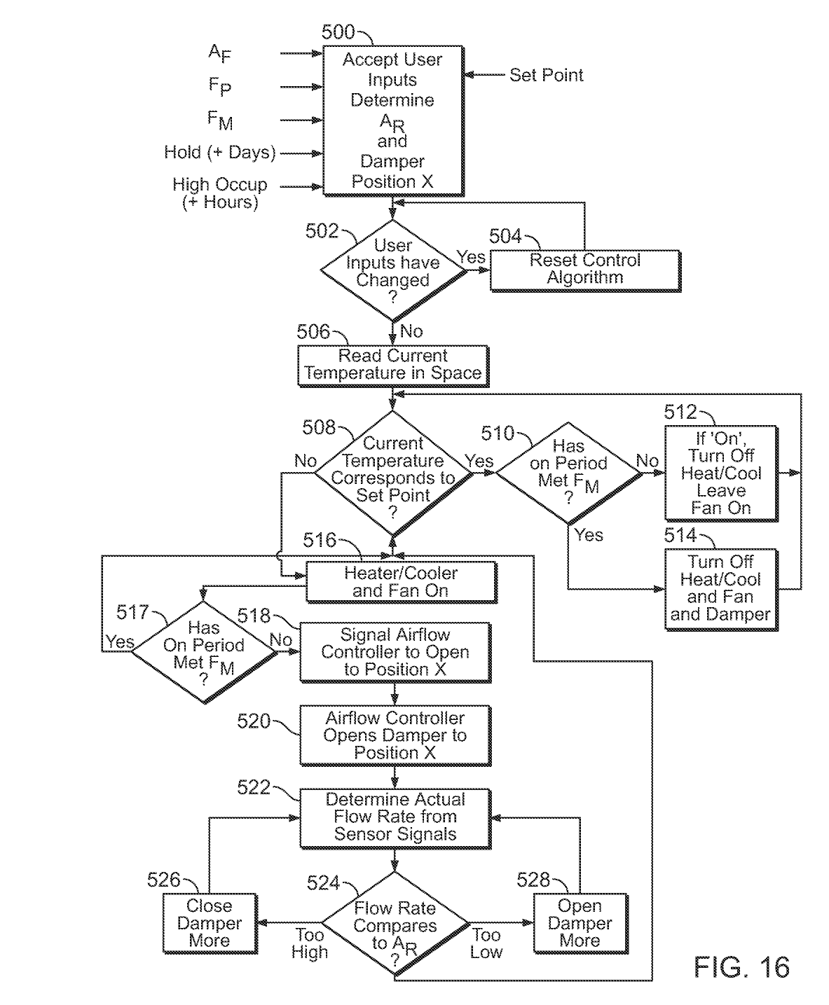

FIG. 16 is a flowchart.

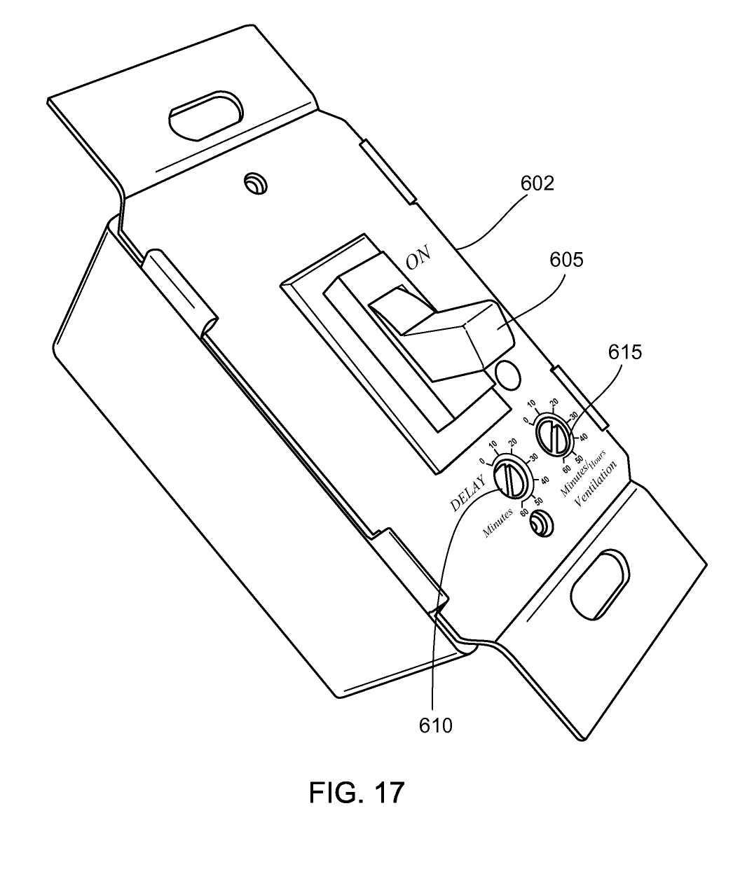

FIG. 17 is a diagram of an example fan and light controller.

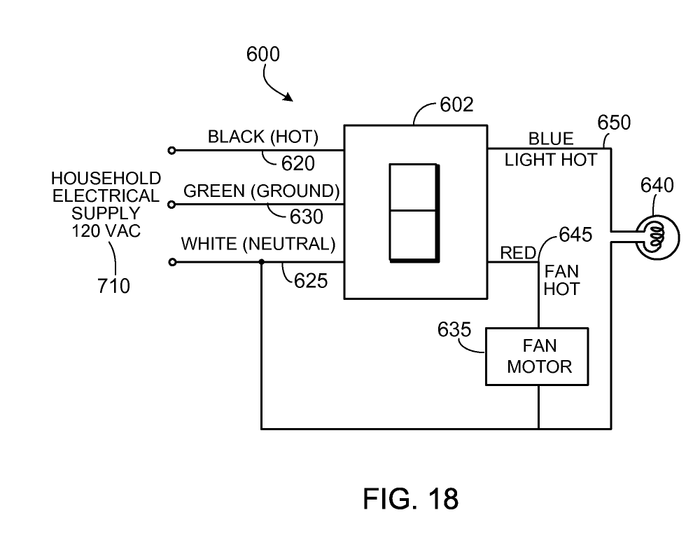

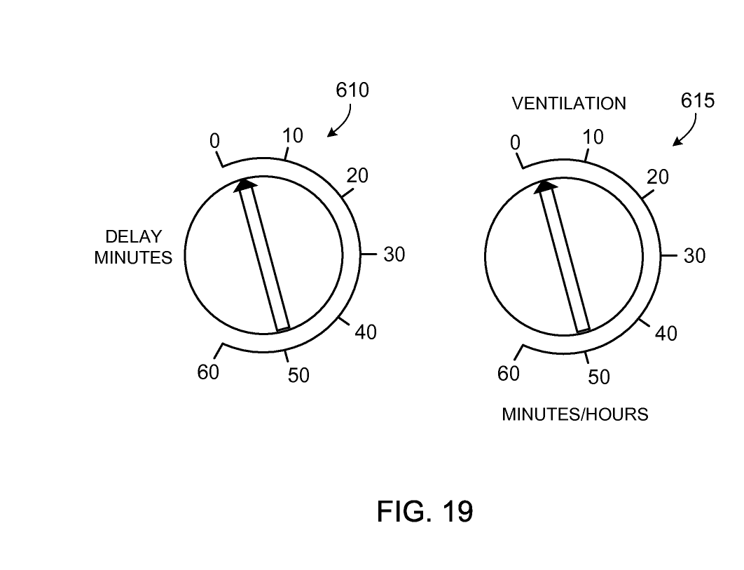

FIG. 18 is a connection diagram of an exhaust control system.

FIG. 19 is a detail of example delay and ventilation controls.

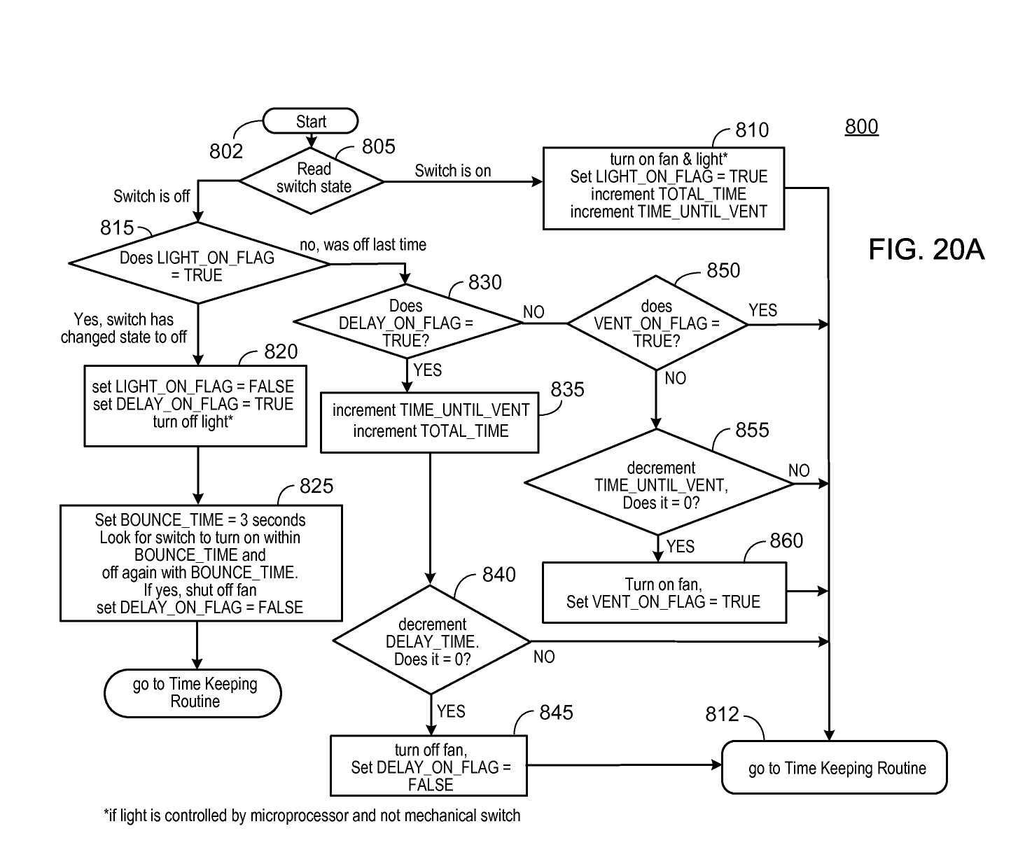

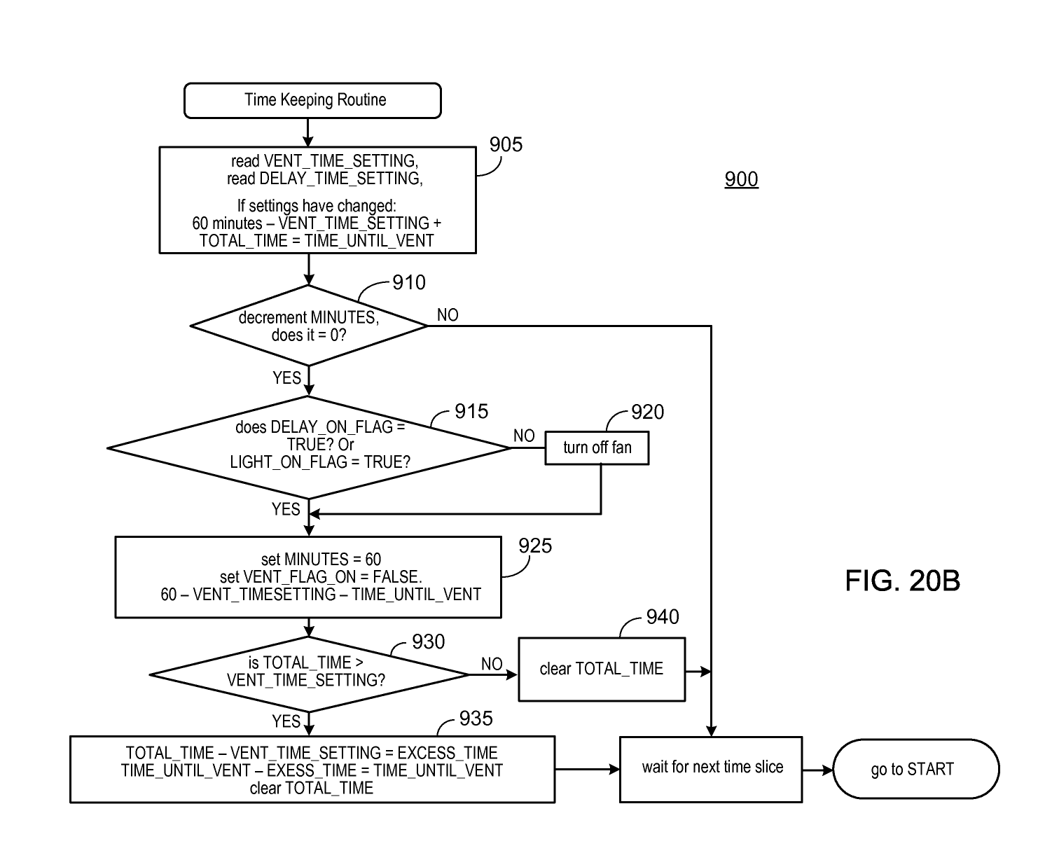

FIGS. 20A and 20B are flowcharts.

As shown in FIG. 2, an airflow sensing unit 52 can be placed in the flow path of outside air 13 (or other source of replacement air) that is passing from the outside environment 12 to an intake port 54 of the air handler 32 from an outside air vent 90. (We use the phrase air handler in a very broad sense to include any kind of equipment that processes air for the purpose of providing, for example, heating, cooling, or ventilation in a space.) The air flow sensing unit 52 includes an air flow sensor (hidden in FIG. 2) that produces a stream of signals from which the volume of air that passes along the air path per unit of time (e.g., 20 cubic feet per minute, CFM) may be derived.

The derivation of the CFM can be done, in one example, by a processor in a local electronic circuit 56 (which we sometimes call an airflow controller) that is mounted on the sensing unit 52 or, in another example, can be sent by a cable 58 to a thermostat and controller 60 (which we sometimes call simply a controller or a main controller) mounted on a wall 62 of a space of a building.

The main controller 60 contains a thermostat circuit that compares data indicative of the temperature in the space with a desired set point temperature. In some implementations, the controller itself may not contain a temperature sensor but may be connected as a controller to an existing thermostat and in that role monitors the existing thermostat. The controller 60 sends control signals on a cable 66 to a set of drivers 68 on the air handler to control heating and cooling to drive the temperature in the space to reach the set point and to control central fan operation during heating and cooling and at other times. The controller 60 may also receive data on a cable 70 from an outside sensor 72 that senses one or both of the relative humidity and temperature of the outside air and may use the data as part of an algorithm that determines when to call for heating or cooling.

For example, if the controller determines that the outside temperature is cooler than the inside temperature at a time when cooling is being requested, the controller could open the damper fully and turn on the central fan for a period to attempt to cool the space with outside air without using the cooling feature of the air handler. The converse determination could be made for heating when the outside temperature is warmer than the inside temperature.

If the outside relative humidity is high during a call for cooling, the controller could allow the space to be cooled a small amount lower than the set point to allow long cooling runs to dry out the inside air. Short cycling the air handler for cooling tends not to remove much water from the air, which can occur if a system is over-sized. In another use, if the outside air temperature is close to the inside air temperature, which could result in relatively little fresh air being provided to the space, the damper may be open fully or for a longer period to increase the fresh air delivered.

These control features could also be based on signals from an inside relative humidity sensor.

In another application, when the weather is cold and dry outside, and the inside relative humidity is elevated, the controller may open the damper more fully or for a longer period to reduce the inside relative humidity.

The main controller 60 also is configured to send damper control signals to control a motor 78 that is mounted on a damper 50 and can drive the damper to any position between full closed and full open (the full open position may be, e.g., 90 degrees from its closed position). The damper control signals may be sent on cable 58 through the airflow controller 56 to the motor driver. The controller can open and close the damper for any number, frequency, and length of time periods and by any amounts within the operating range of the damper. The main controller uses an algorithm and circuitry (discussed later) to determine the time periods and the degree of opening that will be applied for each time period.

The airflow controller drives the damper to the desired position in the following way: The damper motor may be a 1 rpm motor, for example, so that the passage of time can be used to determine position. For example, running the motor for 15 seconds puts the damper full open at 90 degrees. The motor can be indefinitely stalled without damage, so each time the damper is to be closed fully it is run longer than necessary and stalls in the full closed position, which effectively resets it to a known position. Because the motor is run on alternating current, which is closely regulated by the power company, and because the clock speed of the microprocessor is relatively accurate, position can be determined accurately based on time.

The damper 50 and the air flow sensing unit 52 have cylindrical outer walls and are arranged in line together with a flange 82 to form a vent insert 84. The vent insert can be installed in line with and between a standard vent pipe 86 and the rectangular intake port of the air handler. The other end of vent pipe 86 passes through a wall 88 of the building and connects to the outside vent cover 90.

As shown in FIGS. 3, 4, and 5, the damper 50 includes a molded cylindrical body 94 and a molded flat round vane 95. Approximately halfway along the inner wall of the body 94 is a circular rim 96 that projects into the space within the cylindrical body to define a closed position at which the damper is stopped as it is rotated to the closed position. On the outer wall of the body 94, a flat surface 98 is defined to support an electric stepper motor and gear assembly 100 used to drive the damper to selected positions based on signals sent from the controller.

At two diametrically opposite positions around the rim 96 are two holes 90, 92. The vane 95 (which is not shown in FIGS. 3 and 4) has two slightly offset (along an axis normal to the vane) semicircular plates 97, 99, joined at a central tube 91. The damper is held in place in the body 94 by two pins 93, 97 (FIG. 3), one that projects from hole 90 into one end of the central tube. One end of the other pin is connected to a shaft of the motor and gear assembly 100. The other end of that pin projects into the other end of the central tube 91 and is keyed into that hole so that rotation of the motor causes rotation of the damper.

The circular end 102 of the body of the damper 50 that connects to the sensor unit has projecting fingers 106, 108 that mate with and lock into corresponding holes 109, 111 (FIG. 6) in a body of the sensor unit. The other end 103 of the body of the damper 50, which connects to the flange 82, has two holes 110, 112 to receive projecting fingers similar to the fingers 106, 108.

Referring to FIG. 7, the flange 82 has a round end 120 having an inside diameter that is slightly larger than the outside diameter of the end of the damper with which it mates. Two fingers 122, 123 project into the space defined by the round end 120 and mate with the holes 110, 112 of the damper. All of the fingers 106, 108, 122, 123 have tapered leading edges to permit then to be easily forced into the mating holes and have blunt trailing edges to make them hard to remove from the mating holes except by inserting a tool through the holes and against the fingers to force them out of the holes.

The flange 82 includes a square cross-section tapered wall 126 that tapers from the round end 120 to a square cross-section to the opposite square end 128 of the flange. The square end is defined by a rail 130 that is formed along three sides of the square end. The fourth side 132 has no rail.

The rail 130 includes a mounting lip 134, 135 having a row of screw holes for use in mounting the flange to the sheet metal wall of the air handler. The three sides of the rail define a square pocket at the square end of the flange that is larger than the inlet port of the air handler and is deep enough to receive an air filter (not shown), e.g., a standard square air filter or a custom one.

As shown in FIG. 6, the airflow sensing unit 52 has a molded cylindrical body 140. One end 142 of the body has a tapered section 144 to enable the unit to be inserted and held within the inner diameter of the vent pipe 86. The other end 146 of the unit has an enlarged cylindrical section 148. The inner diameter of the section 148 is large enough to receive the outer diameter of the end of the damper.

The outer wall of the body 140 supports a box 150. The electronic circuit 56 (not shown in FIG. 6), which we also call an airflow controller, is held in the box. Inside the body 140, four wings 156 (arranged at 90-degree intervals) extend from the inner wall of the body to a central axis 158. At the central axis, a ring 160 is supported on the wings. A hole 162 in the ring is sized to receive a pin that is used to mount a fan.

As shown in FIG. 8, the fan 164 that is mounted on the body 140 has four identical fan blades 166 evenly spaced around a hub 168 that has a mounting hole 170 and a central axis 172. The fan blades are mounted at an angle to the axis. The hub is mounted on the ring 160 (FIG. 6) using a pin (not shown) that permits the fan to rotate freely about the axis 158, 172. A magnet 173 is mounted near the outer end of each of the fan blades.

As shown in FIGS. 3 and 9, when assembled, one end 103 of the damper 94 is inserted into the round end 120 of the flange until the two fingers on the flange latch into the two holes in the damper. The other end 102 of the damper is inserted into the larger end 148 of the sensor unit 146 until the fingers on the damper snap into the corresponding holes in the sensor unit. The resulting assembly 180 is then installed in the building by screwing the flange to the air handler and inserting the free end of the sensor unit into the vent pipe. The motor 100 of the damper is connected to a source of power and the signal lines among the airflow controller and the damper are connected to the main controller. A filter is inserted into the pocket at the interface between the air handler and the flange.

Once the assembly 180 has been installed, when the damper is open and air is drawn into the air handler from the outside, the air moves through the sensor causing the fan to rotate. The fan rotates more rapidly with higher velocity of air motion. The rotation of the fan is indicative of the air flow volume per unit time. As the fan rotates, the airflow controller detects when each of the magnets on the blades passes the location of a magnetic detector that is part of the airflow controller. The airflow controller then determines the RPM (which may be the instantaneous RPM in some examples, or an averaged RPM in other examples). Based on the RPM signals, the main controller converts the RPM signals to a flow rate in CFM, for example, by using a stored look-up table that associates flow rates with rotation rates as determined empirically.

The airflow controller circuitry 202 and the main controller circuitry 204 and their interconnections are shown in FIG. 10.

The main controller includes a microprocessor 204, a display 206 that is controlled by the microprocessor, and a keyboard 208 that enables a user to manage the operation of the main controller. In one implementation, the keypad provides eight keys (membrane switch keys 1 through 6, and up, down, and mode buttons), and the display has the configuration shown in the figure. The microprocessor includes control outputs 209 for the fan driver 210, the heat driver 212, a second heat driver 214, and a cooling driver 216. The outputs are carried on a cable 66 to the air handler where the drivers are located.

The main controller includes a thermistor 218 to detect the temperature within the space being heated or cooled. The main controller may also include a relative humidity sensor 220. Optionally, the microprocessor can also receive signals from an outside temperature sensor and an outside relative humidity sensor 72 that are mounted in a position exposed to the outside world. Data to be sent back and forth between the main controller and the airflow controller on the cable 58 is handled by a network interface 222 at the main controller end of the cable and a corresponding network interface 224 on the airflow controller end of the cable.

The airflow controller 202 includes a microprocessor 230, which receives directives about the timing and degree of opening of the damper from the main controller. The primary output control signals from the microprocessor are clockwise and counterclockwise signals 232, 234 that are delivered to the motor driver 236. In one example, the counterclockwise signals are controlled to cause the damper to move toward the fully open position. The clockwise signals are controlled to cause the damper to return toward the fully closed position. Any degree of opening between fully open and fully closed can be achieved. The airflow controller turns on the central fan whenever the damper is opened. In examples that include a thermostat in the central controller, the controller would cause the central fan to be turned on using a signal 233 produced by the airflow controller. In examples in which the central controller does not include a thermostat, a relay 225 is used to turn on the fan independently of the thermostat.

The fan sensor 240 may be a Hall effect device that detects the passage of each blade of the fan and delivers a corresponding signal to the microprocessor. The microprocessor converts the signals to an RPM value, which is then passed back to the main controller through the network interfaces.

A pushbutton 242 may be used to test the airflow controller, and a tri-color LED 244 is used to indicate the state of the airflow controller. Optionally, the airflow controller can receive signals from incoming air temperature and humidity sensors 248, 246, process the signals to produce raw data, and pass the raw data back to the main controller.

The airflow controller operates as a slave to the main controller and receives and responds to commands from the main controller.

When the main controller commands the slave to open the damper to position x, the airflow controller causes the damper to open to the requested position, x. When the main controller commands the slave to report its status, the airflow controller reports the position of the damper, including the status indicated by its LEDs 244, the state of the push button 242, and any error codes. When the main controller commands the slave to report the fan RPM, the airflow control sends back the value of the fan RPM. When the main controller commands the slave to change the LED's state, the airflow controller replies with an acknowledgement.

FIGS. 11A, 11B, and 11C show a front view with cover closed, a perspective view, and a front view with cover open of the external housing of the main controller. In addition to controlling the fan on periods and the damper open periods, the controller serves as a conventional programmable thermostat. For this purpose it provides keys to program a weekday set point schedule and a weekend set point schedule, and keys to set the day and time. A fifth key controls the set point and a hold key sets the hold function. The two buttons that have up and down arrows are used to increase or decrease a value and the square button serves a similar role to an enter button on a keyboard.

The mode and up and down buttons are used to set Af, Fp, and Fm values (described later). The controller includes a main housing and a base that is attached to the wall. The main housing snaps onto the base. By holding the up button in while snapping the housing to the base, the microprocessor is alerted to enter setup mode. Once in setup mode the display indicates the value that is being set. Pressing the mode button cycles through the three variables that are to be set. When a given variable is in set mode, the up and down arrows control the value of the setting. Other arrangements could be used to invoke the setup mode, for example, pressing a combination of the membrane switches at one time. In some implementations, a separate device may be provided to read out data from the controller and the device may also be able to lock and unlock the settings or to re-program the settings and then lock the settings so that the user is precluded from changing them.

The hold button controls both the hold options and the high occupancy options. The hold options could include setting a number of days for holding, or setting to hold indefinitely. The high occupancy option would hold the setting for a specified number of hours.

To operate the system, the user may use the keypad and the display of the controller to enter several values to be used by the control algorithm. One value is an average desired fresh air flow rate into the space being heated or cooled, called Af and expressed in cubic feet per minute. The user can determine what this value should be by using simple recommendations of another party or by doing a calculation on a website based on the characteristics of the house, and its occupancy. ASHRAE, for example, specifies 15 CFM per person. Or 15 CFM per bedroom+one. For example, the user may set the value of Af to 30 CFM indicating a desire to have an average 30 CFM of fresh air delivered to the space. A second value is the controller duty cycle called Fp and expressed in minutes, which represents the durations of the successive periods over which the algorithm will be applied. A third value is a fan minimum run time, called Fm and expressed in minutes, which represents the minimum number of minutes that the fan should run during each controller duty cycle.

The controller uses the entered values to calculate a required flow rate, called Ar and expressed in cubic feet per minute, which will apply during the periods when the fan is running and the damper is open. Ar is calculated as (Fp/Fm)Af=Ar. For example, if Af=30, Fp=10, and Fm=30, then Ar=90 CFM which is the flow that must be achieved during the periods when the damper is open.

The user can use the controller keypad to override the normal operation of the algorithm by specifying a hold mode or a high occupancy mode.

The hold mode could be applied, for example, during a vacation period when the space will not be occupied. When the user presses the hold button, the controller prompts the user to enter a number of days to hold. The controller then holds the temperature constant at the then current set point and disables setback scheduling for the specified number of days or indefinitely (depending on the setting option that is used. The fresh air flow rate Af is reduced to a pre-set minimum flow rate, for example, 90 CFM. The fan minimum run time Fm is reduced to a pre-set time, for example, 10 minutes.

Another variant of the hold mode could be used in situations in which outside ventilation is being obtained, say, from an opened window in a context in which the thermostat is not calling for either heating or cooling. In such a circumstance, when the user enters the hold mode, he could be given an option to completely disable fan operation and fresh air input, for example, until further input from the user.

The high occupancy mode may be used, for example, when a larger than normal number of people will occupy the space, requiring a higher than normal fresh air flow rate. When the user presses the high-occupancy button, the controller prompts for a number of hours to maintain the high occupancy mode. During the period when the mode is maintained, the temperature is held at the current set point, and setback scheduling may be disabled. The fresh air flow rate Af is increased to a pre-set maximum flow rate, for example 90 CFM. The fan minimum run time, Fr, is increased to a pre-set run time, for example, 10 minutes. During high occupancy mode, if the set point temperature cannot be maintained, then the fresh air flow rate Af will be decreased until the set point temperature is reached. Reducing the fresh air flow rate in this way will enable the heater or cooler to adjust the temperature to the set point.

As shown in FIG. 12, in some control systems a user can indicate the percentage of time (for example, 33%) that he would like the central fan of the air handler to run—whether or not the thermostat is calling for heating or cooling—in order to keep air circulating in the space. Such systems track off time as a control technique. Note that the fan is always on when the thermostat is calling for heating or cooling. During periods when the thermostat is not calling for heating or cooling, the system monitors the amount of off time. If the amount of off time exceeds the desired percentage, then the fan is turned on.

For example, as shown in the figure, the user may specify that the central fan should run 33% of each 30-minute period. Suppose that the thermostat makes no call for heating or cooling at any time during the 30-minute period. Time line 402, in the upper half of the figure, shows the on and off periods of the fan during. For the first 30 minutes, the thermostat is not calling for heating or cooling and the central fan is on 404 for the first 10 minutes, then off 406 for 20 minutes in order to meet the desired percentage of on time. The same pattern is repeated in the second 30 minutes. In this example, the desired proportion of fan on time, 33%, is accurately achieved.

By contrast, in the time line 408, shown in the bottom half of FIG. 12, the desired proportion of fan on time is not met. In this example, the thermostat calls for cooling for 4 minutes 410, followed by an interval 412 of 16 minutes of no cooling, and then the pattern repeats. During the first 4 minute cooling period, the fan runs. When the cooling ends, the fan is turned off. If no cooling were then required for more than 20 minutes, the fan would be turned on by the algorithm, which watches the amount of off time to assure that the fan is never off for a period longer than 20 minutes. However, in the example, a new cooling period is triggered after only 16 minutes causing the fan to go on, so the algorithm never determines that the fan has been off longer than 20 minutes. The same sequence then repeats. As a result, the fan is only on for 12 minutes an hour, instead of the desired 20 minutes per hour, an error of 40% that results in the air in the space being less fresh than desired.

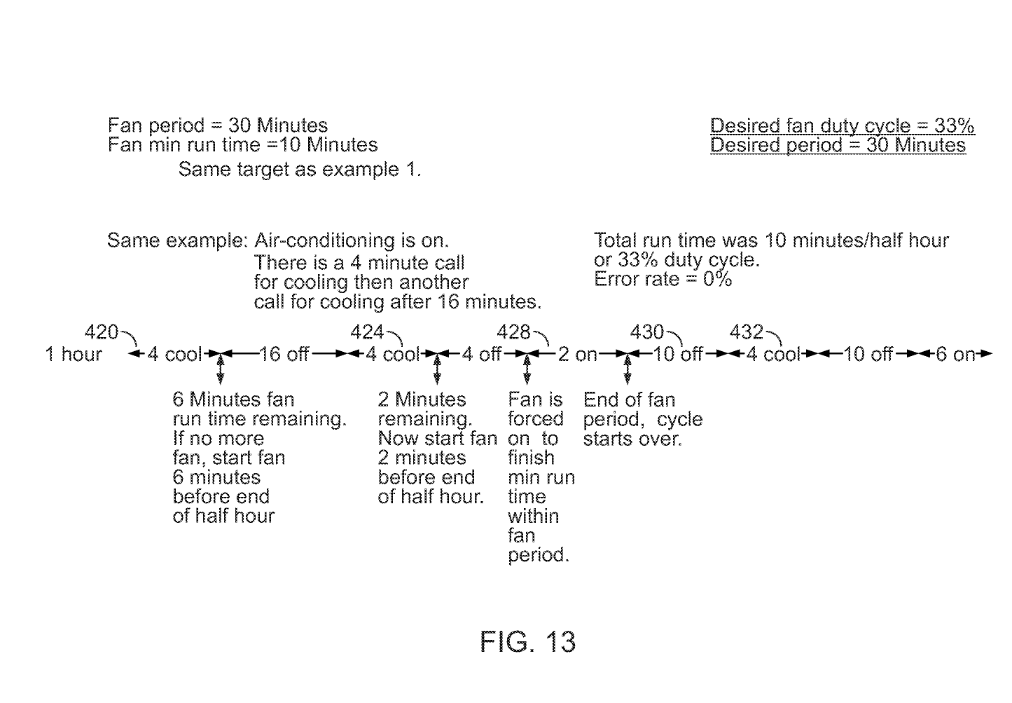

Referring to FIG. 13, in a different approach, it is the on time of the fan that is tracked and the algorithm assures that a minimum desired on time per controller cycle is met. For example, the user may select a fan minimum on time of 10 minutes in each 30-minute period, the same target as in the example of FIG. 12. Suppose that, as in the lower half of FIG. 12, the thermostat calls for cooling for 4 minutes at the beginning of every successive 20-minute period. In the time-line 420, the fan runs during the initial 4-minute cooling period 422. At the end of that period, when the fan is turned off, the controller (which is tracking the on time to see if it meets the desired value) determines that, to satisfy the desired 10 minutes of fan on time for the first 30 minutes will require that the fan be operated another 6 minutes no later than at the last portion of the 30-minute period. At the end of the second 4-minute period 424, the controller determines that 8 minutes of the needed 10 minutes of fan on time have occurred, with two minutes remaining. At the end of an additional 4 minutes of off time 426, only 2 minutes remain in the half-hour period, so the controller turns on the fan for a 2-minute period 428 to meet the goal. Next the remaining 10 minutes of the 16-minute off period 430 occurs, and the fan remains off during that period. After the next four-minute off period 432, the controller determines that 6 more minutes of fan on time are required in that half hour. So the controller allows the fan to remain off for another 10-minute period 434 and then turns it on for the final 6-minute period 436 of the second half-hour. The fan on time then exactly matches the desired on time of 20 minutes for the hour.

If, near the end of the system cycle (30 minutes in the above example), the time remaining for the fan to be run is small, say less than 3 minutes, the algorithm could decide not to run the fan, or to defer the needed time to the next cycle. This may reduce complaints by users that would otherwise be generated when they hear the fan run for short periods of time.

Thus the controller is able to achieve the desired fan on time with no excess (which wastes power and may take in too much air) and no shortfall (which may leave the air in the space stale).

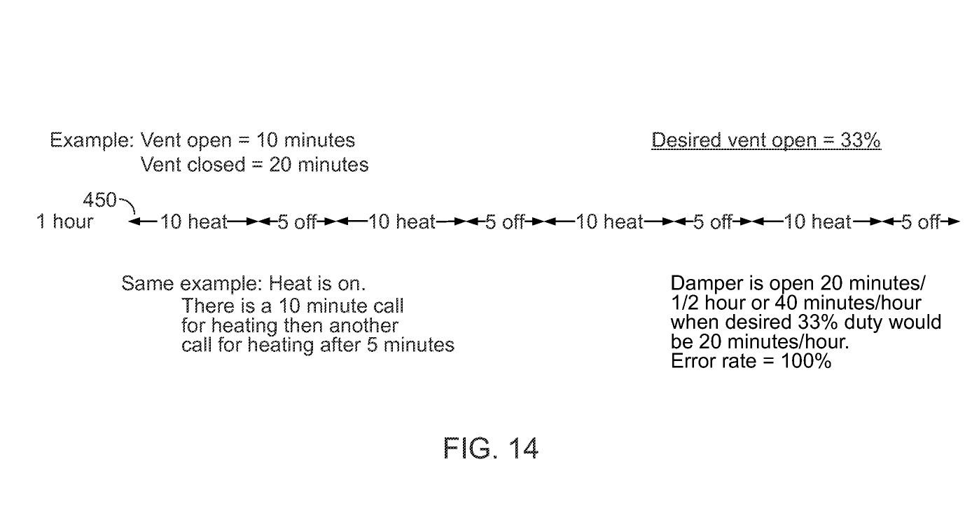

FIGS. 12 and 13 are focused on the timing of fan on and off periods. We now consider how the damper may be controlled to assure that a desired amount of fresh air is provided to the space. FIG. 14 illustrates that some known systems for controlling the open or closed state of the damper (vent) do not accurately meet the desired proportion of open time. As shown in the example, in such systems the user can specify the proportion of time that the vent is open, say, 33%, which corresponds to 10 minutes open and 20 minutes closed per half hour.

Suppose that, in the example, the thermostat is calling for heat for 10 minutes at the beginning of each successive 15-minute period. In the known system, the vent is open when and only when the fan is operating. Because the operation of the fan to serve the heating need is more than enough tot meet the desired 10 minute per half hour vent open time, the time line 450 represents the periods when heat is and is not being called for, and implicitly when the fan is running and not running and the damper is open and not open. In the example, the total fan on time and hence the total damper open time is 40 minutes during the hour, or 66% of the time, which is an error of 100% in the desired proportion of damper open time. Because the damper is open more time than is needed, energy will be wasted.

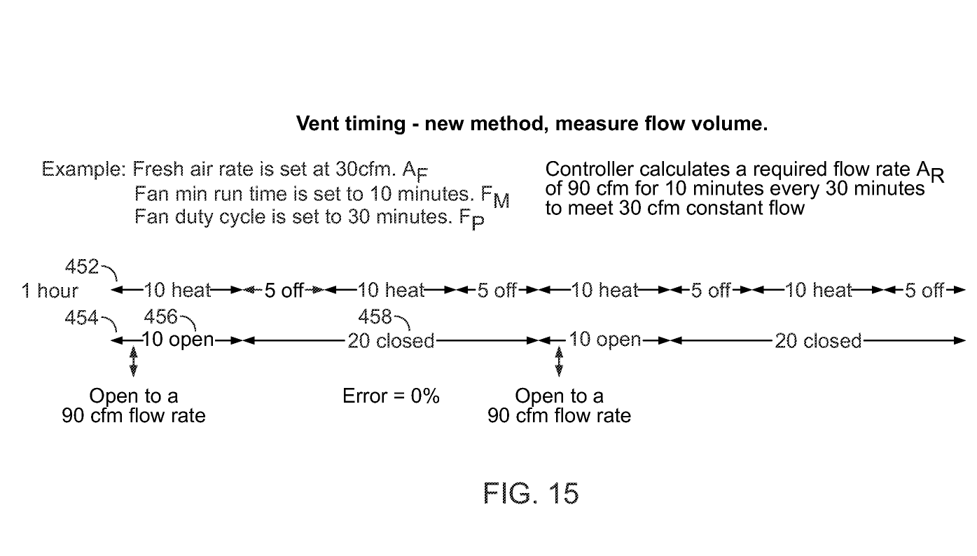

In a different control approach, illustrated in FIG. 15, the user specifically sets the fresh air rate Af at, say, 30 CFM, the minimum fan run time Fm at 10 minutes, and the duty cycle Fr at 30 minutes. The controller uses these settings to calculate a required flow rate of 90 CFM to be achieved for 10 minutes in every 30-minute period. The upper time line 452 in FIG. 15 shows, as did the time line in FIG. 14, the periods when the heat is and is not being called for. The lower time line 454 in FIG. 15 shows the periods when the damper is open and closed. In the initial 10-minute period 456, when the fan is running, the damper is opened enough to achieve a 90 CFM flow rate, as determined by the controller. In the next, 20-minute period 458, running to the end of the half-hour, the damper is closed because the controller has determined that the quota of damper open time for that half hour has been met. The periods are then repeated in the second half hour. Unlike the system shown in FIG. 14 (which does not allow the user to specify flow rates), the desired flow rate/time schedule is met exactly in FIG. 15.

Portions of the algorithm used for the main controller and the airflow controller are shown in FIG. 16. At block 500, the controller accepts inputs from the user that may include Af, Fp, Fm, Hold, High Occupancy, and a set point. If the user inputs have changed any of those values, 500, the system resets the control algorithm accordingly 504. Otherwise the controller reads the current temperature setting from the sensor in the space 506. If the current temperature corresponds to the current set point, 508, the controller determines whether the on period of the fan has met the value Fm. If not, the controller turns off the heater or cooler (if it was already on) and leaves the fan on. If so, the controller turns of the heater or cooler (if it was already on) and turns of the fan and closes the damper. Then the controller returns to check the temperature against the set point again.

If the temperature does not correspond to the set point, the controller turns on the heater or cooler 516 and tests whether the on period of the fan has met Fm. If so, the controller returns to check the temperature against the set point again. If not, the controller signals the airflow controller 518 to open the damper to position x. The airflow controller opens the damper to position x 520 and then determines the actual flow rate using the sensor signals 522. Next the airflow controller compares the flow rate to Ar. If the flow rate is too low, the airflow controller opens the damper by an increment 528; if too high, the airflow controller closes the damper by the increment 526. If the damper is already fully open or fully shut, an error can be signaled by the main controller. If a fully open damper does not provide enough total air flow in some cases the controller could increase Fm. Or the controller can signal an error and ask the user to check the filters. If neither too low nor too high, the airflow controller so indicates to the main controller which then again tests the temperature against the set point.

The requirement for minimum airflow in a space could be one set by an industry standards group, for example, ASHRAE, or could be one set by a user or by a manufacturer of air handlers or by a builder of the house or other structure. For example, the builder may know the building leaks more than intended so that less than the recommended amount of fresh air needs to be provided to the space. Or even tighter building techniques could produce a need for higher than previously recommended fresh air replacement rates Conversely it could be yet a new building method where the home was tighter.

By monitoring the airflow and/or the damper position over time in a given system, it is also possible to determine when the filter needs to be cleaned or replaced. Decreases in the airflow rate will indicate blockage of airflow. When the airflow falls below a predetermined value, an indicator can tell a user that it is time for filter maintenance. The predetermined value may be set empirically for systems in general, or for each installed system in particular. Empirical analysis may not be required, because filter maintenance time may also be inferred from the profile of declining airflow. For example, the algorithm could watch for an abrupt change in airflow as an indicator that a filter situated upstream of the central fan is clogged. In that circumstance, the damper would be held open all the time and yet not be delivering the needed fresh air.

If the filter is on the downstream side of the central fan, as the filter clogs more air will be drawn from the outside, increasing air flow and drawing in more air than is appropriate to mix with the recirculated air. In the latter case, when the filter clogs, the pressure in the air handler drops and the flow from the outside world increases. The algorithm would detect these events and trigger an indicator that the filter should be replaced or cleaned.

When a new filter is installed, the algorithm could determine that fact automatically by watching for a prolonged abrupt decrease or increase in air flow that lasts at least, say, 10 minutes. The algorithm could then store the air flow rate for the new filter. When the air flow rate increases or decreases from the new filter rate by a change amount that is predetermined the filter maintenance alarm would be raised.

Before a filter is fully clogged and as it becomes slowly clogged from its new state, the algorithm will automatically accommodate the change in air flow. Thus the system will achieve both a longer effective filter life and simultaneously achieve a more constant and precise air flow rate.

The techniques described above may be used in connection with an exhaust fan, e.g., a bathroom exhaust fan and a light, e.g., a bathroom ceiling light. Referring to FIG. 17, in one example, a controller 602 comprises a toggle switch 605, a delay period control 610 for setting a delay time period length, and a ventilation period control 615 for setting a ventilation time period length.

Referring to FIG. 18, in one example, in an exhaust control system 600, the controller 602 is electrically connected to a household electrical supply 710 through electrical supply wires, which include a hot wire 620, a neutral wire 625, and a ground wire 630. The controller 602 is also connected to an exhaust fan 635, and a light 640, via fan hot wire 645 and light hot wire 650, respectively. Accordingly, controller 602 may selectively supply electric power to exhaust fan 635 and light 640. The controller 602 also includes a microprocessor (not shown) that is programmed to carry out instructions for controlling the operation of the exhaust fan 635 and light 640 by controlling the supply of electric power to them.

FIG. 19 provides detail of the delay period control 610 and the ventilation period control 615. In some implementations, both controls 610, 615 may be implemented as potentiometers that may be set to a number of minutes between 0 and 60. The potentiometers are, in turn, connected to, e.g., analog to digital converters (not shown) that translate the respective potentiometer settings to digital values that are provided to controller 600. In one embodiment, the controls 610, 615 are recessed knobs that may be adjusted with a screwdriver.

The system 600 allows for establishing a delay time period length for the fan 635. As described above, a user may specify the delay time period through the delay period control 610. When the controller 602 is placed in a first state (i.e., the switch 605 is turned on), the system 600 activates the fan 635. The fan 635 runs for the delay time period length even after the controller 602 enters a second state (i.e., the switch 605 is turned off). For example, assuming a delay time period length of 1 (one) minute, the user turns on the switch 605, uses the bathroom for 4 minutes, then turns off the switch 605. The controller 602 will cause the fan 635 to operate for the 4 minutes the switch 605 is “on” plus the additional one minute of delay time period length, for a total of 5 minutes.

In some examples, the system 600 may be configured to require that the switch 605 be on for at least a certain amount of time (e.g., 10 seconds) before the fan 635 is turned on.

Sometimes, when a user enters a bathroom for only a brief amount of time, the user may not want the fan 635 to continue to operate for the entire delay time period. That is, the user may wish to cancel the delay routine, i.e., the routine that activates the fan 635 for the delay time period described below. Accordingly, after using the bathroom, the user may perform a user action in connection with the switch 605 to cancel all or a part of the delay routine. For example, the user on exiting the bathroom may turn the switch 605 off (thus turning off the light 640), and further to cancel the delay time period for which the fan 635 runs, the user may toggle the switch 605 quickly between on and off. The bounce time is the time within which if the switch 605 is turned on and again off, the fan 635 is turned off and the delay routine is canceled. As such, if the user causes the switch 605 to be turned on and again off within at least the bounce time (e.g., 3 seconds), the delay routine will be cancelled, and the fan 635 is immediately turned off by the controller 602.

In some examples, only after the switch 605 and thus the light 640 has been continuously on for at least 10 seconds, the system will activate the delay time period.

In some examples, after a switch 605 has been turned off, during the corresponding delay time period when the fan 635 is running, any subsequent toggling of the switch 605 may have no effect on the fan 635 operation. Accordingly, in these examples, only after the fan 635 has completed operating for the duration of the delay time period, will the system 600 be available to be operated for further delay time periods.

In one implementation, the system 600 for controlling the exhaust fan 635 may also allow the user to specify a ventilation time period for the fan 635. In such an implementation, the system 600 ensures that the fan 635 is run for at least the ventilation time period.

In one embodiment, the ventilation time period length is a minimum amount of time that the user wishes the fan 635 to operate (e.g., 20 minutes) during a predetermined period of time (e.g. an hour). In this regard, the system 600 ensures that for a given predetermined period of time, i.e., the hour, the fan 635 runs for at least the ventilation time period, i.e., 20 minutes. Accordingly, if in a given hour the switch 605 is not turned on (and thus the fan 635 has not been run), the system 600 automatically activates the fan 635 at about 40 minutes into the hour for at least the remainder of the hour, i.e., 20 minutes.

Further, consider a scenario in which the ventilation time period length is 20 minutes per hour, and the delay time period is specified to be 1 (one) minute. During a given hour, the switch 605 is turned to activate the fan 635 and the light 640. For example, the user enters the bathroom and uses the bathroom for about 4 minutes. Thus, the fan 635 has been running for 4 minutes. When the user exits the bathroom and turns the switch 605 off, the light 640 immediately turns off, but the fan 635 runs for an additional delay time period length of one minute for a total time of 5 minutes. In this scenario, at approximately 45 minutes into the hour, the system 600 will automatically run the fan 635 for another 15 minutes so that the total time that the fan 635 has run in the hour is the ventilation time period, i.e., 20 minutes.

In an implementation, if the fan 635 has already run for more than the ventilation time period, e.g., the user has used the bathroom for 24 minutes and the fan 635 has run for an additional delay time period of 1 minutes, then the excess time over the ventilation time period, i.e., 5 minutes, is carried over to the next hour. Consequently, in the next hour, the new ventilation time period length is 20−5=15 minutes.

In an implementation, if during an hour the switch 605 is turned on two or more times to activate the fan 635 such that the sum of the corresponding delay time periods is more than the ventilation time period for the hour, then the excess time period is subtracted from the next hour's ventilation time period. For example, consider a scenario in which the delay time period is set to 1 minute and the ventilation time period is set to 30 minutes. If the switch 605 is turned on at the beginning of an hour and left on for 19 minutes, and then, 20 minutes later the switch 605 is again turned on and left on for 19 minutes, the fan 635 runs for the sum of the on periods and the corresponding delay time periods, i.e., 40 minutes. In the following hour, the excess time period of 10 minutes is subtracted from the next hour's ventilation time period. Accordingly, if the switch 605 is not turned on during the following hour, the fan 635 automatically runs for a ventilation time period of 20 minutes.

In some examples, the controller 602 may have a control that permits the ventilation time period length to be specified different from one hour to the next, e.g., 30 minutes of a first hour and 10 minutes of a second hour. In some examples, a first ventilation time period length (e.g., 10 minutes) can be specified for hours in a first part of a day (e.g., night time, from 12 PM to 6 AM, when minimum exhaust fan 635 usage is desired) and a second ventilation time period length (e.g., 30 minutes) can be specified for hours in a second part of the day (e.g., afternoon, from 1 PM to 5 PM, when maximum exhaust fan 635 usage is desired).

Referring now to FIGS. 20A-B, in an implementation, a method for controlling the exhaust fan 635 and light 640 operates according to algorithm 800 discussed in detail below. The algorithm 800 may be executed by the controller 602 having e.g., a microprocessor controlling the fan 635 and light 640 through digital signals.

The algorithm 800 operates as a polling routine. At a pre-determined rate (e.g., once every quarter second), the algorithm 800 is executed by the microprocessor. The algorithm 800 polls the state of the switch 605 and takes appropriate action in response. In one embodiment, the predetermined rate is slow enough to debounce mechanical chatter associated with the closure of switch 605 and quick enough to provide a perceived instant response to the user. Because the algorithm 800 executes at regular intervals, the passage of time may be tracked by incrementing or decrementing variables (implemented as e.g., registers in the microprocessor) each time the algorithm 800 is executed. Each increment or decrement corresponds to the length of the interval, e.g. ¼ second.

Stepping through the algorithm 800, the state of the toggle switch 605 is read to determine whether the switch 605 is in the “on” position (step 805). If the toggle switch 605 is in the “on” position, the fan 635 is turned on, the LIGHT_ON_FLAG variable is set to value “TRUE,” and the TOTAL_TIME variable (that keeps track of the total time that the fan has been running during the hour), and the TIME_UNTIL_VENT variable (that keeps track of the time in the hour that must have elapsed before automatic venting should commence) are incremented (step 810). In embodiments in which the light is controlled by the microprocessor (as opposed to a mechanical switch), step 810 also turns on light 640. Control is then passed to the time keeping routine 900 of FIG. 20B described in detail below (step 812).

If the toggle switch 605 is not in the “on” position (i.e., it is “off”), the state of the switch 605 may have just changed to “off.” The status of LIGHT_ON_FLAG is read to determine if the state of the switch 605 has just changed to off (step 815). If the LIGHT_ON_LAG is set to value “TRUE,” then the LIGHT_ON_LAG is toggled to value “FALSE” to power off the light 640 (step 820). In the same step 820, the DELAY_ON_FLAG is set to value “TRUE” to indicate that the delay routine is operational. If the light 640 is controlled by the microprocessor, the light is turned off during step 820. Further, the algorithm 800 listens for a toggling of the switch 605 by the user for canceling the delay routine.

The cancellation of the delay routine proceeds as follows (step 825). A BOUNCE_TIME variable is set to a predetermined value, e.g., 3 seconds, corresponding to a bounce time. (In subsequent passes through the algorithm, BOUNCE_TIME is decremented each time through an auxiliary routine (not shown), until it reaches zero. If switch 605 is toggled “on” again and “off” again while BOUNCE_TIME is still greater than zero, then the fan 635 is turned off and DELAY_ON_FLAG is set to FALSE.) Control is then passed to the time keeping routine 900 (step 812).

Referring again to step 815, if the LIGHT_ON_is set to value “FALSE,” then the switch 605 may have been off for some time. The status of the DELAY_ON_FLAG is read to determine whether the delay routine is operational and the fan 635 is still running (step 830) If the fan 635 is still running, the TIME_UNTIL_VENT and TOTAL_TIME variables are incremented (step 835). Further, the DELAY_TIME variable, which keeps track of the length of the delay routine, is decremented (step 840). If the DELAY_TIME variable has a value of 0 (zero), then the delay routine has ended and the fan 635 is turned off (step 845). Accordingly, the DELAY_ON_FLAG variable is set to value “FALSE.”Subsequently, control is transferred to the time keeping routine (step 812).

Referring back to step 830, if the delay routine is not operational, i.e., DELAY_ON_FLAG variable is set to value “FALSE,” and the fan 635 is turned off, then the algorithm 800 checks to see if automatic ventilation has begun (i.e., the fan has been turned on independently of the light switch to insure a minimum amount of ventilation during the hour) by testing the VENT_ON_FLAG variable (step 850). If the VENT_ON_FLAG variable is set to value “TRUE,” (and automatic ventilation is ongoing) then control is transferred to the time keeping routine 900 (step 812). If the VENT_ON_FLAG variable is set to value “FALSE,” then the TIME_UNTIL_VENT variable is decremented and checked to see if it has reached value 0 (zero) (step 855). If the TIME_UNTIL_VENT reaches value 0 (zero), i.e., the time within the hour until the beginning of automatic ventilation has elapsed, then the VENT_ON_FLAG is set to value “TRUE” to enable automatic ventilation and the fan is turned “on” (step 860). Subsequently, control is once again transferred to the time keeping routine 900 (step 812).

In general, the time keeping routine 900 (FIG. 20B) begins by reading the values specified by the user through the delay period control 610 and the ventilation period control 615 and accounts for the minutes in an hour. The value specified by the delay control 610 is captured by the DELAY_TIME_SETTING variable. The value specified by the ventilation control 615 is captured by the VENT_TIME_SETTING variable. If these settings have been changed since the last time they were read by the time keeping routine 900, then the TIME_UNIT_VENT variable is reset according to the expression TIME_UNTIL_VENT=60 minutes VENT_TIME_SETTING+TOTAL_TIME (step 905).

Next the MINUTES variable is decremented and tested to see if it equals 0 (zero). (step 910). The MINUTES variable keeps track of the minutes in the hour that have elapsed. If the MINUTES variable reaches zero, then the hour has ended. If MINUTES equals zero, the status of the DELAY_ON_FLAG and the LIGHT_ON_LAG variables are read to determine if the delay routine is operational or if the light is on (step 915). If the delay routine is not operational or the light 640 is off, then the fan 635 is turned off (step 920). Next, the MINUTES variable is reset to 60 minutes and the VENT_ON_FLAG is set to value “FALSE”, and TIME_UNTIL_VENT is set equal to 60−VENT_TIME_SETTING (step 925). Next, the total time that the fan 635 has been running as indicated by the value in the variable TOTAL_TIME is compared with the value of the VENT_TIME_SETTING variable (step 930). If the value in the TOTAL_TIME variable is greater than the value in the VENT_TIME_SETTING variable (indicating that the fan 635 ran more than minimum required time during the past hour), the excess time value (EXCESS_TIME) is set as the difference between the TOTAL_TIME and VENT_TIME_SETTING, TIME_UNTIL_VENT is decremented by EXCESS TIME and TOTAL_TIME is reset to zero (step 935). If, at step 930, TOTAL_TIME is not greater than VENT_TIME_SETTING, then TOTAL_TIME is reset to zero (step 940).

Finally, before control is transferred back to the START 802 of the algorithm 800, the time keeping routine 900 waits until the end of the time slice (step 940).

Other implementations are within the scope of the following claims.

The controller may be used not only to control dampers but also turn on and off a heat recovery ventilator (which may be used to exchange heat from outgoing air with the incoming air) or an in-line boost fan (which could be used to bring more fresh air into the system in the case of long intake duct run, for example) or an exhaust fan (in a balanced ventilation system). The airflow controller may have an auxiliary output that will signal anytime the damper is open (in any position). The output may go to a relay board that can be used to turn on and off anything else that a user might want to control.

The air sensing unit, the damper, and the flange need not be interconnected as an assembly and can be mounted separately or in pairs (or as the complete assembly) anywhere along the air intake duct. The assembly can comprise any two of the three units with the third one being installed separately. The damper need not be custom made to couple to the other two units, but rather can be a commercially available motor driven damper.

The airflow sensor could be implemented in a variety of ways that include a rotating fan and in ways that do not involve a fan. Air flow could be sensed using a hot wire anemometer, for example. The sensor could be designed to measure air pressure rather than fan rotation and the algorithm could infer air flow from changes in the air pressure within the intake duct.

Other algorithms could be used to determine how to control the damper to achieve a desired profile of air flow.

Controlling of the duty cycle of the damper in the fully open and fully closed states may be a simple and economical way to achieve a desired average flow rate, and controlling of the duty cycle might be combined with controlling the amount of opening and closing of the damper to achieve a precise instantaneous air flow rate.

The techniques described above may be implemented in a wide variety of machines, including hardware, software, firmware, or combinations of them. The implementations may be part of or include other devices, such as thermostats or other controllers. When microprocessors are used, they are controlled by software that is written in or compiled into or interpreted in their native language. The software may be stored or communicated in a variety of media including, for example, memory, flash memory, mass storage devices, network based communication channels, buses, or wirelessly.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

Other embodiments are within the scope of the following claims and other claims to which the applicant may be entitled. The following are examples for illustration only and do not limit the alternatives in any way. The techniques described herein can be performed in a different order and still achieve desirable results

Other implementations are within the scope of the following claims and other claims to which the applicant may be entitled.

1. A method for controlling a fan and a light, comprising:
establishing a ventilation time period length; and
during a predetermined period of time:
(i) operating said light in response to a user placing a controller in a first state;
(ii) operating the fan during a first period of time corresponding to the time when the light is in operation, in response to the controller being placed in the first state;
(iii) discontinuing operation of the light in response to the controller entering a second state;
(iv) discontinuing operation of the fan in response to the controller entering the second state; and
(v) automatically operating the fan for a second period of time in addition to said first period of time, when the light is not in operation, such that the fan is operational for a total period of time having at least the ventilation time period length.

2. The method of claim 1, further comprising:
establishing a delay time period length; and
during the predetermined period of time, in response to the controller entering the second state, operating the fan for a third period of time after the first period of time, the third period of time having at least the delay time period length.

3. The method of claim 2, further comprising automatically operating the fan for the second period of time in addition to the first period of time and the third period of time, when the light is not in operation, such that the fan is in operation during the predetermined period of time for a total period of time having at least the ventilation time period length.

4. The method of claim 2, further comprising after the controller has entered the second state, in response to a user action in connection with the controller, discontinuing operation of the fan.

5. The method of claim 4, in which the user action comprises, after the controller is in the second state, causing the controller to be sequentially placed in the first state and the second state within a predefined interval of time.

6. The method of claim 2, further comprising in response to the controller entering the second state, operating the fan for a third period of time after the first period of time if the first period of time has at least a certain length.

7. The method of claim 2, further comprising if a total time comprising the first period of time and the third period of time has a length that exceeds the ventilation time period length by an excess time amount, subtracting the excess time amount from a next ventilation time period length corresponding to a next predetermined period of time.

8. The method of claim 1, in which the ventilation time period length is specified by a user.

9. The method of claim 2, in which the delay time period length is specified by a user.

10. The method of claim 1, in which the fan comprises a bathroom exhaust fan.

11. A medium bearing instructions for controlling a fan and a light, the instructions causing a machine to:
establish a ventilation time period length; and
during a predetermined period of time:
(i) operate said light in response to a user placing a controller in a first state;
(ii) operate the fan during a first period of time corresponding to the time when the light is in operation, in response to the controller being placed in the first state;
(iii) discontinue operation of the light in response to the controller entering a second state;
(iv) discontinue operation of the fan in response to the controller entering the second state; and
(v) automatically operate the fan for a second period of time in addition to said first period of time, when the light is not in operation, such that the fan is operational for a total period of time having at least the ventilation time period length.

12. The medium of claim 11, further bearing instructions to cause a machine to:
establish a delay time period length; and
during the predetermined period of time, in response to the controller entering the second state, operate the fan for a third period of time after the first period of time, the third period of time having at least the delay time period length.

13. The medium of claim 12, further bearing instructions to cause a machine to: automatically operate the fan for the second period of time in addition to the first period of time and the third period of time, when the light is not in operation, such that the fan is in operation during the predetermined period of time for a total period of time having at least the ventilation time period length.

14. The medium of claim 12, further bearing instructions to cause a machine to:
after the controller has entered the second state, in response to a user action in connection with the controller, discontinue operation of the fan.

15. The medium of claim 14, in which the user action comprises after the controller is in the second state causing the controller to be sequentially placed in the first state and the second state within a predetermined time interval.

16. The medium of claim 12, further bearing instructions to cause a machine to:
in response to the controller entering the second state, operate the fan for a third period of time after the first period of time if the first period of time has at least a certain length.

17. The medium of claim 12, further bearing instructions to cause a machine to:
if a total time comprising the first period of time and the third period of time has a length that exceeds the ventilation time period length by an excess time amount, subtract the excess time amount from a next ventilation time period length corresponding to a next predetermined period of time.

18. A controller for controlling a fan and a light comprising:
a switch;
a processor in communication with the switch a first control in communication with the processor to establish a ventilation time period length; and
wherein said processor and switch control the light and the fan by, during a predetermined period of time:
(i) operating the light in response to a user placing the switch in a first state;
(ii) operating the fan during a first period of time corresponding to the time when the light is in operation, in response to the switch being placed in the first state;
(iii) discontinuing operation of the light in response to the switch entering a second state;
(iv) discontinuing operation of the fan in response to the switch entering the second state; and
(v) automatically operating the fan for a second period of time in addition to said first period of time, when the light is not in operation, such that the fan is operational for a total period of time having at least the ventilation time period length.

19. The controller of claim 18 further comprising:
a second control in communication with the processor, to establish a delay time period length;
the processor configured to, during the predetermined period of time, in response to the controller entering the second state, operate the fan for a third period of time after the first period of time, the third period of time having at least the delay time period length.

20. The controller of claim 19, wherein the processor is configured to automatically operate the fan for the second period of time in addition to the first period of time and the third period of time, when the light is not in operation, such that the fan is in operation during the predetermined period of time for a total period of time having at least the ventilation time period length.

21. The controller of claim 19, wherein the processor is configured to, after the switch has entered the second state, in response to a user action in connection with the switch, discontinue operation of the fan.

22. The controller of claim 21, in which the user action comprises after the switch is in the second state causing the switch to be sequentially placed in the first state and the second state within a predefined interval of time.

23. The controller of claim 19, wherein the processor is configured to, in response to the switch entering the second state, operate the fan for a third period of time after the first period of time if the first period of time has at least a certain length.

24. The controller of claim 19, wherein the processor is configured to, if a total time comprising the first period of time and the third period of time has a length that exceeds the ventilation time period length by an excess time amount, subtract the excess time amount from a next ventilation time period length corresponding to a next predetermined period of time.

25. A fan controller comprising:
(a) A manually operable switch having an “on” and an “off” position;
(b) a delay input for specifying a delay time setting;
(c) a ventilation input for specifying a ventilation time setting;
(d) a control logic for controlling the powered state of the fan so that,
the fan is powered “on” when the manually operable switch is in an “on” position;
the fan remains powered on for a number of minutes determined by the delay time setting after the manually operable switch is placed in an “off” position; and
during a given predetermined time period, the fan is powered on for at least the amount of time specified by the ventilation time.

26. A fan controller comprising:
(a) A manually operable switch having an “on” and an “off” position;
(b) a delay input for specifying a delay time setting;
(c) a control logic for controlling the powered state of the fan so that,
the fan powered “on” when the manually operable switch is in an “on” position; and
the fan remains powered on for a number of minutes determined by the delay time setting after the manually operable switch is placed in an “off” position, unless the manually operable switch is switched “on” and “off” in a pre-defined sequence within a pre-defined period of time, in which case the fan is substantially immediately powered off.
